(19) United States
(12) Patent Application Publication
(10) Pub. No.: US 2021/0303009 A1
(43) Pub. Date: Sep. 30, 2021

(54) Heater with Energy Save Function

(71) Applicant: World & Main (Cranbury) LLC, Cranbury, NJ (US)

(72) Inventor: John H. Bavoso, Hamilton Square, NJ (US)

(21) Appl. No.: 17/223,080

(22) Filed: Apr. 6, 2021

Related U.S. Application Data
(63) Continuation-in-part of application No. 17/203,226, filed on Mar. 16, 2021.
Application No. 17/203,226 is a continuation-in-part of application No. 17/203,226, filed on Mar. 16, 2021.
Application No. 17/203,226 is a continuation-in-part of application No. 17/202,161, filed on Mar. 15, 2021.
(60) Provisional application No. 63/002,951, filed on Mar. 31, 2020.
(60) Provisional application No. 63/002,958, filed on Mar. 31, 2020.
(60) Provisional application No. 63/002,965, filed on Mar. 31, 2020.

(51) Int. Cl. G05D 23/19; F24H 9/20

(52) U.S. Cl. CPC G05D 23/1923; F24H 9/2078

(57) ABSTRACT

A heating appliance has a multi-position control switch with a non-off lower than highest setting at an extreme distal position and consumes a non-off lower than highest amount of power at that position. The non-off lower setting is indicated as an energy saving setting. The switch has an off position at an extreme proximal position and the appliance consumes no power at that position. The switch has a highest setting position between the proximal and distal positions and the appliance consumes a highest amount of power at that position.

### FIELD OF THE INVENTION

The present invention is related to heating appliances. More specifically, it is related to circuitry for portable electric room heaters.

### BACKGROUND

Portable electric room heaters are well known. Such heaters typically draw up to 1500 W of electricity and convert that to heat because 1500 W is the maximum allowed by any unattended and continuously operating electrical appliance. Yet 1000 W will typically provide sufficient heat in a reasonable time to warm a typical room.

Suppliers make 1500 W heaters because they know that consumers seek optimal performance when making their purchasing decisions. It is no more expensive to manufacture a 1500 W heater than a 1000 W heater, so suppliers are inspired to give consumers what they want rather than what they need.

Operation at such a high wattage as 1500 W has numerous drawbacks. For instance, such a wattage is taxing on supply wiring and the internal wiring and components or the appliance. Also, such energy consumption is expensive. And because such heat may quickly overwarm a small room, continued operation at 1500 W after a comfortable temperature is reached is wasteful and counter-productive.

Heaters are usually designed to provide multiple levels of heating. For instance, a typical heater will have a switch with an Off setting, a Low setting of 500 W, a Medium setting of 1000 W, and a High setting of 1500 W. It is found through testing that uncomfortably cold users are prone to turn or slide the power switch to its most extreme position when they first turn it on, often without even looking at the markings for each switch position, so to avoid wasting energy once the room is satisfactorily warm, many such heaters employ a thermostat to de-energize the heater once a desired room temperature is realized and re-energize it once a certain lower temperature is realized.

A drawback in such an arrangement is that such thermostats will always have some degree of hysteresis, so the room temperature typically cycles from a temperature below desired to the temperature desired, which creates discomfort. Another drawback is that in heaters having a mechanical thermostat with electric contact points, the on/off cycling at the highest setting will more rapidly case oxidation and failure of the thermostat.

A user may overcome this drawback by operating the heater on a higher wattage setting until the room is satisfactorily warm, then turning the heater down to a lower wattage setting to maintain the desired temperature without such cycling, but such manual attention is inconvenient and oftentimes not possible.

There exists a need for, and it is an object of the invention to provide a heating appliance that causes inattentive users to operate the appliance at a lower than highest setting.

There exists a need for, and it is an object of the invention to provide a heating appliance that inspires attentive users to operate the appliance at the lower setting.

There exists a need, and it is an object of the invention to provide a heating appliance that prolongs the life of its mechanical thermostat by causing or inspiring use at the lower setting.

Further needs and objects exist which are addressed by the present invention, as may become apparent upon review of the included disclosure of exemplary embodiments thereof

### SUMMARY OF THE INVENTION

The invention may be embodied in or practiced using an electrical heating appliance having improvements which may include a lower than highest setting at the most extreme switch position so that inattentive users who are prone to turn the heater on to its switch's most extreme position will be inadvertently setting it to that lower setting. Additionally, the lower setting is indicated to be an “Energy Save” to inspire more attentive users to move the switch to that setting as well.

The invention may also be embodied in or practiced using a heating appliance having a multi-position control switch with a non-off lower than highest setting at an extreme distal position where the heater consumes a non-off lower than highest amount of power at that position. The non-off lower setting may be indicated as an energy saving setting. The switch may have an off position at an extreme proximal position and consume no power at that position. The switch may have a highest setting in a position between the proximal and distal positions and consumes a highest amount of power at that position. The heating appliance may include a heater and a thermostat adapted to allow selection of a desired room temperature, wherein the thermostat senses an ambient room temperature, enables energization of the heater when the ambient room temperature is below the desired room temperature, and disables energization of the heater when the ambient room temperature is at or above the desired room temperature.

Alternatively, the switch may have an extreme proximal position and consume less than the non-off lower than highest amount of power at that position, and the switch may have a highest setting a position between the proximal and distal positions and consume a highest amount of power at that position.

Further features and aspects of the invention are disclosed with more specificity in the Detailed Description and accompanying drawings of an exemplary embodiment provided herein.

### BRIEF DESCRIPTION OF THE DRAWINGS

Many aspects of the invention can be better understood with reference to the included Drawings showing exemplary embodiments for practicing the invention which corresponds to the accompanying Detailed Description. The components in the Drawings are not necessarily to scale, emphasis instead being placed upon clearly illustrating the principles of the invention. Moreover, like reference numerals in the Drawings designate corresponding parts throughout the several views.

FIG. 1 is a perspective view of a first portable electric heating appliance according to or for use in practicing the invention;

FIG. 2 is a front view of the appliance of FIG. 1;

FIG. 3 is a partial view showing the controls of the appliance of Fig .1;

FIG. 4 is a partial exploded view of the appliance of FIG. 1;

FIG. 5 is a full side cross section of the appliance of FIG. 1;

FIG. 6 is a perspective view of the heating element of the appliance of FIG. 1;

FIG. 7 is a circuit diagram of the appliance of FIG. 1;

FIG. 8 is a perspective view of a second portable electric heating appliance according to or for use in practicing the invention;

FIG. 9 is a front view of the appliance of FIG. 8;

FIG. 10 is a top view showing the controls of the appliance of FIG. 8;

FIG. 11 is a partial exploded view of the appliance of FIG. 8;

FIG. 12 is a full side cross section of the appliance of FIG. 8;

FIG. 13 is a front view of the heating element of the appliance of FIG. 8; and

FIG. 14 is a circuit diagram of the appliance of FIG. 8.

### DETAILED DESCRIPTION OF AN EXEMPLARY EMBODIMENT

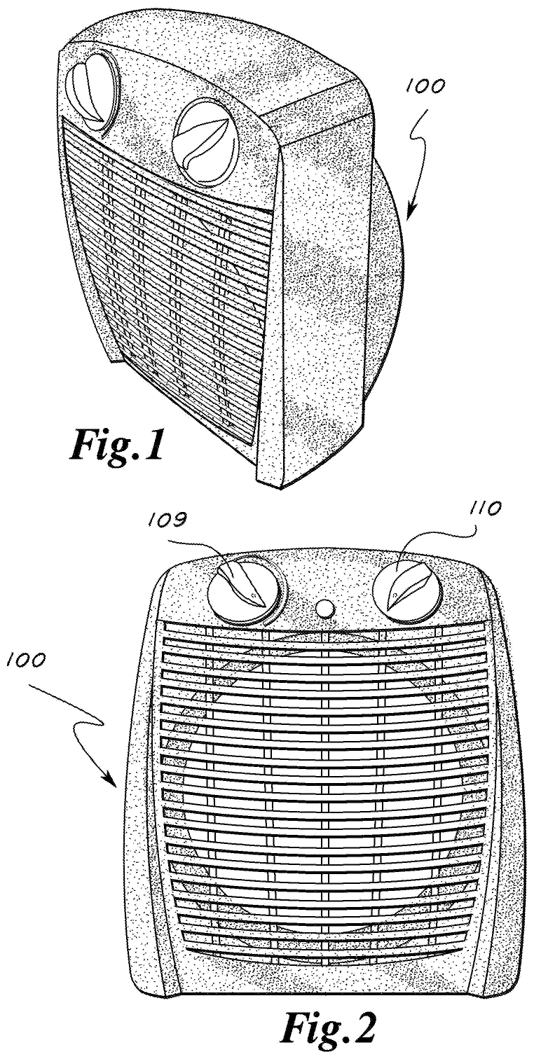

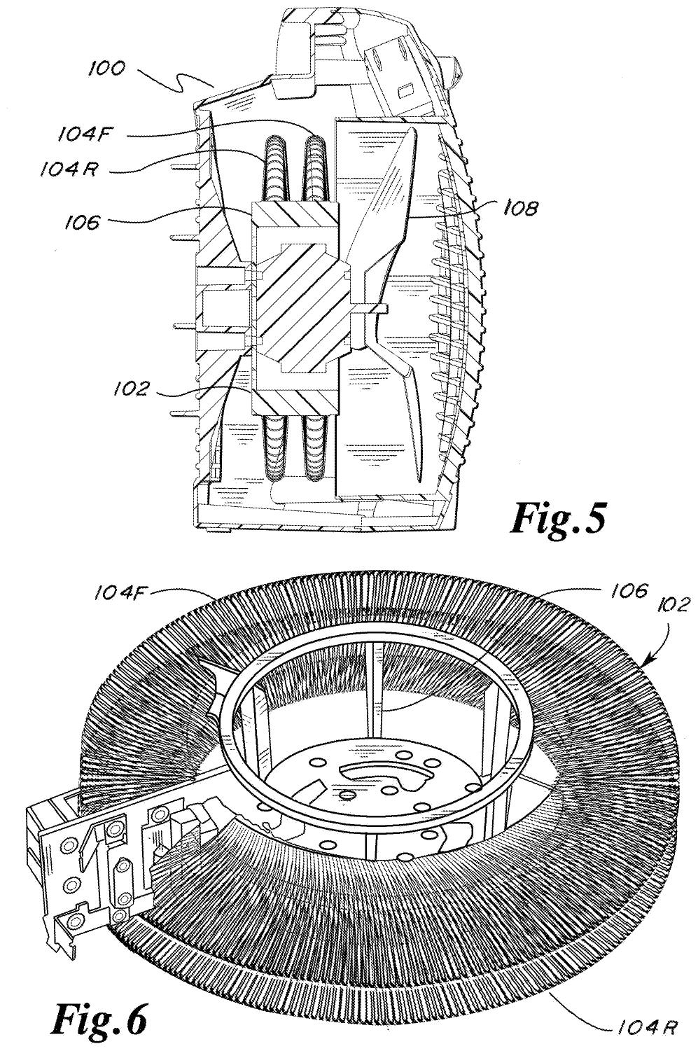

A first exemplary heating appliance 100 is shown in FIGS. 1 through 7, which has a heating element assembly 102. The heating appliance may have any one of many shapes, configurations, and control panel arrangements, with those shown being merely exemplary as shown throughout the accompanying images.

The heating element assembly includes two lengths of resistance wire, 104F and 104R, each wound spirally into a torus shapes coil and supported by a circular insulator, 106, and stacked in front-to-rear alignment as shown in FIG. 6. Such is a common arrangement in such electric heaters, with the two coils having different resistances such that power to both will provide a high wattage output, power to only the coil with the lesser resistance will provide a medium wattage output, and power to only the coil with the higher resistance will provide a low wattage output.

When it is energized, fan 108 forces air through heating coils through the coils to extract the heat therefrom, then forces that air forwardly from the appliance and into the surrounding environment. The fan then further forces that heated air forwardly from the appliance and into the surrounding environment.

Adjustable thermostat 109 allows the user to select a desired room temperature and causes de-energization of the heating element and fan when that temperature is sensed and re-energization when the room temperature falls back down to some lower temperature.

Control switch 110 has an Off position 112 during which the coils and the fan are not energized and has High Power 114 and Medium Power 116 positions. The Medium Power position is marked as an “Energy Save” position.

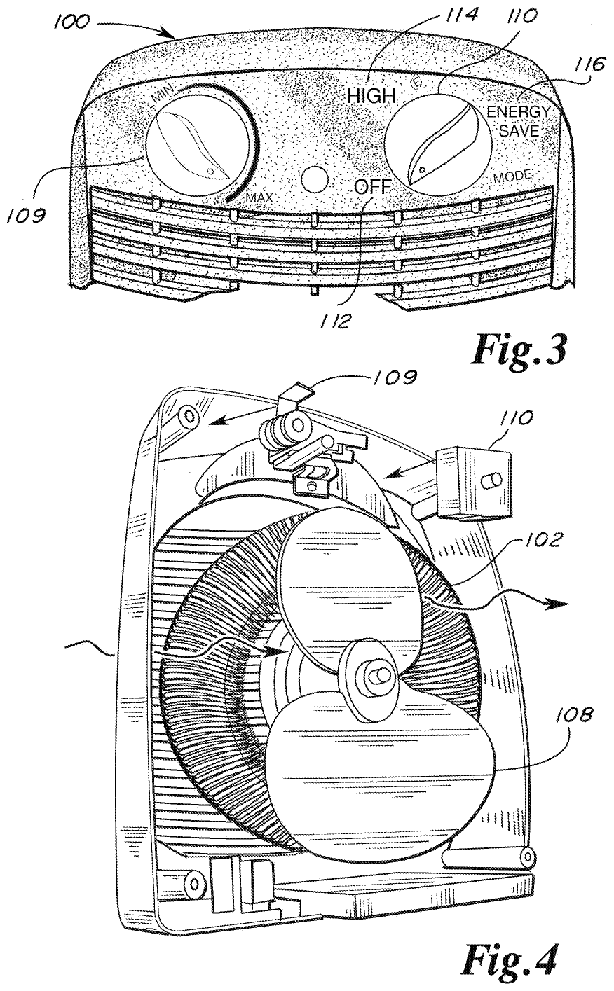

As seen best in FIG. 3, the switch positions are arranged proximal to distal; Off, High, and Energy Save, in that order.

It is found that positioning the Medium (Energy Save) setting at the most extreme distal switch position causes inattentive users who are prone to turn the heater on to the switch's most extreme position to inadvertently set the heater to that lower setting, which is safer, consumes less electricity, and is less taxing on the thermostat.

The Medium setting is so indicated to be an Energy Save setting to inspire more attentive users to move the switch to that setting, which is safer, consumes less electricity, and is less taxing on the thermostat.

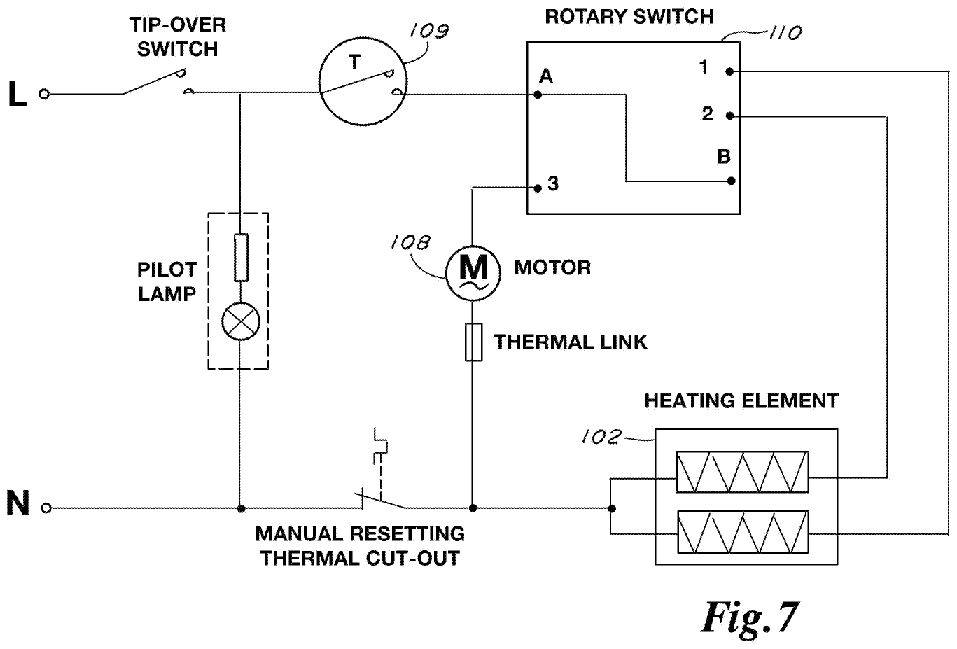

FIG. 7 is the self-explanatory circuit diagram of appliance 100.

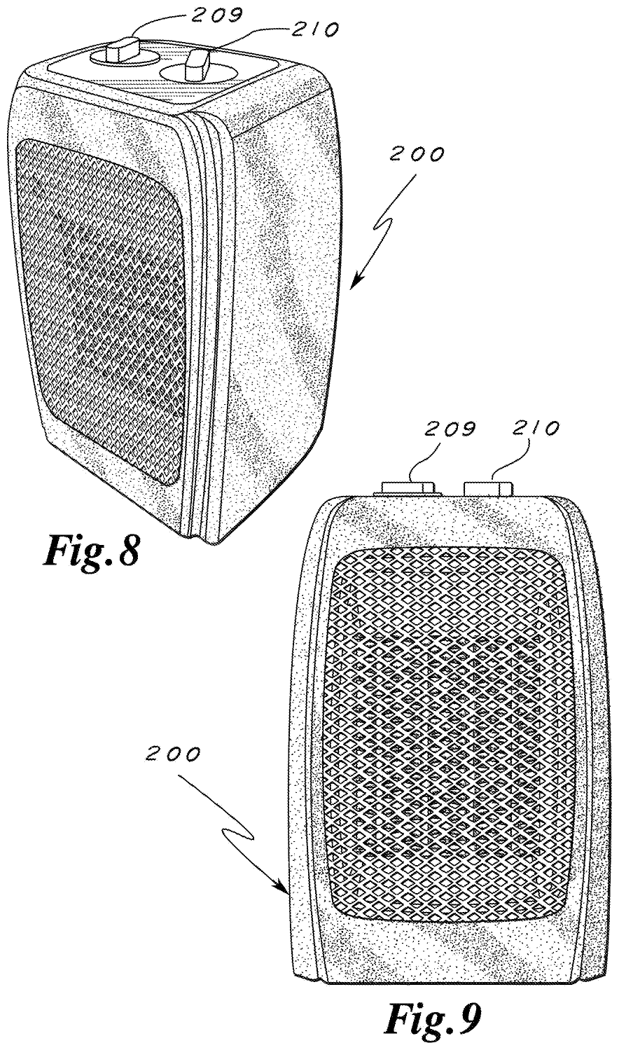

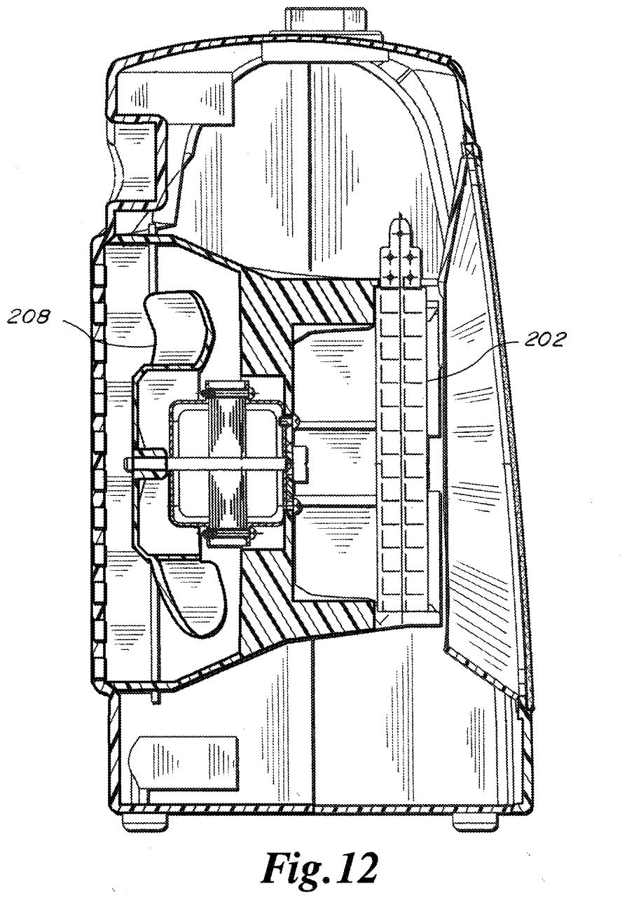

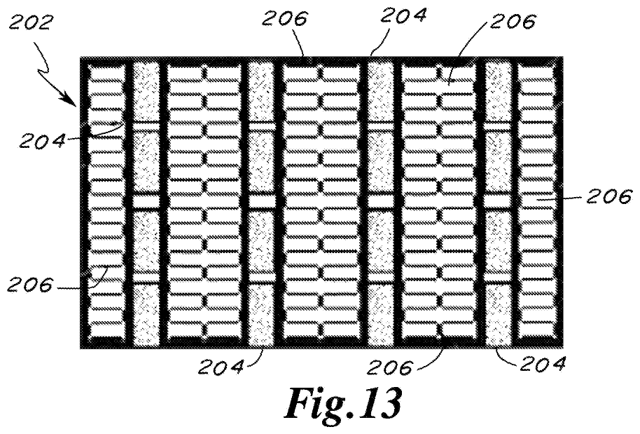

A second heating appliance 200 is shown in FIGS. 8 through 14, which has a positive thermal coefficient (PTC) heating element array 202. The heating appliance may have any one of many shapes, configurations, and control panel arrangements, with those shown being merely exemplary as shown throughout the accompanying images.

The heating element includes a PTC array having PTC chips 204 embedded within porous heat-exchanging radiators 206. It is the nature of the PTC chips that a voltage there-across will cause the chip to become hot, and that heat will conduct to the heat radiator/radiators with which it is in contact. All PTC chips may be energized to cause maximum heating, fewer for lower heating, and still fewer for lowest heating.

When it is energized, fan 208 forces air through the porous radiators to extract the heat therefrom, then forces that air forwardly from the appliance and into the surrounding environment. The fan then further forces that heated air forwardly from the appliance and into the surrounding environment.

Adjustable thermostat 209 allows the user to select a desired room temperature and causes de-energization of the PTC array and fan when that temperature is sensed and re-energization when the room temperature falls back down to some lower temperature.

Control switch 210 has an Off position 212 during which the array and the fan are not energized and has High Power 214 and Medium Power 216 positions. The Medium Power position is marked as an “Energy Save” position.

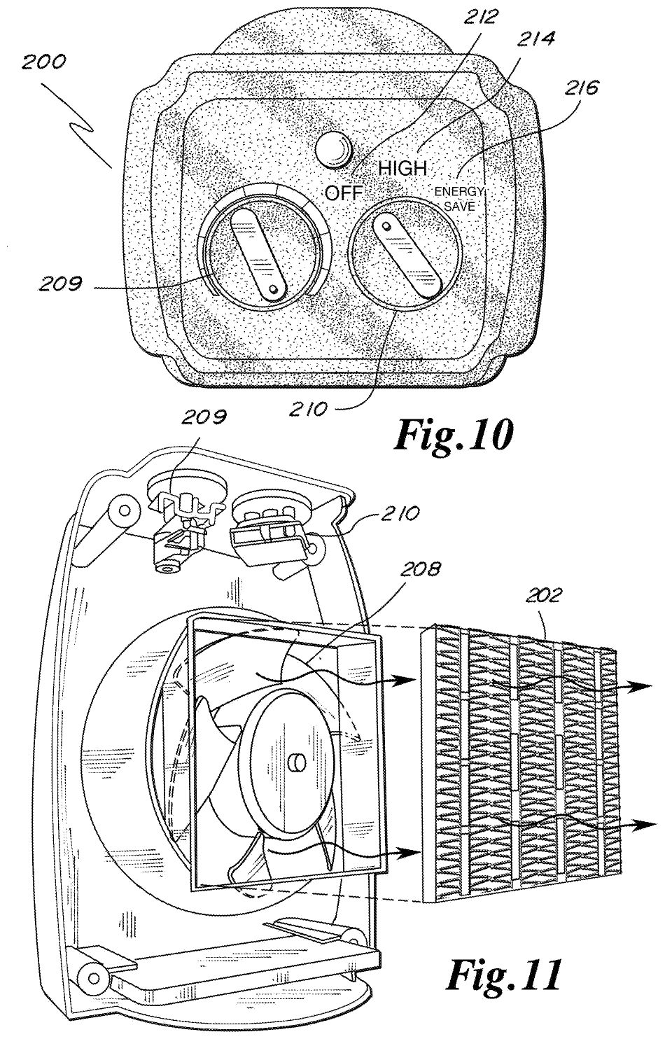

As seen best in FIG. 10, the switch positions are arranged, proximal to distal, Off, High, and Energy Save, in that order.

It is found that positioning the Medium (Energy Save) setting at the most extreme distal switch position causes inattentive users who are prone to turn the heater on to the switch's most extreme position to inadvertently set the heater to that lower setting, which is safer, consumes less electricity, and is less taxing on the thermostat. The Medium setting is so indicated to be an Energy Save setting to inspire more attentive users to move the switch to that setting, which is safer, consumes less electricity, and is less taxing on the thermostat.

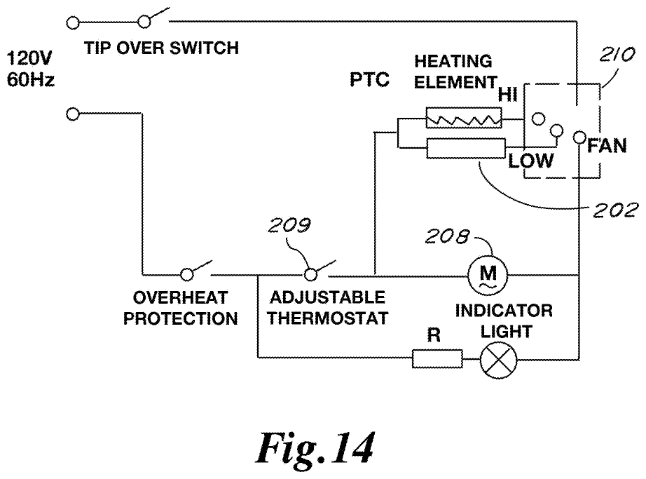

FIG. 14 is the self-explanatory circuit diagram of appliance 200.

Shown in the two embodiments is a co mon rotary switch, but it is anticipated that the switch could alternatively be a common slide switch or any other equivalent. Various other changes in form and detail may be made without departing from the spirit and scope of the invention, so the invention should therefore only be considered according to the following claims, including all equivalent interpretation to which they are entitled.

I claim:

1. A heating appliance having a multi-position control switch with a non-off lower than highest setting at an extreme distal position and which consumes a non-off lower than highest amount of power at that position.

2. The heating appliance of claim 1 wherein the non-off lower setting is indicated as an energy saving setting.

3. The heating appliance of claim 2 wherein the switch has an off position at an extreme proximal position and the appliance consumes no power at that position.

4. The heating appliance of claim 3 wherein the switch has a highest setting position between the proximal and distal positions and the appliance consumes a highest amount of power at that position.

5. The heating appliance of claim 4 further comprising a heater and a thermostat adapted to allow selection of a desired room temperature, wherein the thermostat senses an ambient room temperature, enables energization of the heater when the ambient room temperature is below the desired room temperature, and disables energization of the heater when the ambient room temperature is at or above the desired room temperature.

6. The heating appliance of claim 2 wherein the switch has an extreme proximal position and the appliance consumes less than the non-off lower than highest amount of power at that position.

7. The heating appliance of claim 6 wherein the switch has a highest setting position between the proximal and distal positions and the appliance consumes a highest amount of power at that position.

8. The heating appliance of claim 7 further comprising a heater and a thermostat adapted to allow selection of a desired room temperature, wherein the thermostat senses an ambient room temperature, enables energization of the heater when the ambient room temperature is below the desired room temperature, and disables energization of the heater when the ambient room temperature is at or above the desired room temperature.
